(19) United States
(12) Patent Application Publication
(10) Pub. No.: US 2004/0069922 A1
(43) Pub. Date: Apr. 15, 2004

(54) Assembled sunshade base

(76) Inventor: Weidan Wu, Gaojian Xiang (CN)

Correspondence Address: KAPLAN & GILMAN , L.L.P., 900 ROUTE 9 NORTH, WOODBRIDGE, NJ, 07095, US

(21) Appl. No.: 10/632,060

(22) Filed: Jul. 31, 2003

(30) Foreign Application Priority Data
Oct. 9, 2002 (CN) 02260609.2

(51) Int. Cl. F16M 13/00

(52) U.S. Cl. 248/519

(57) ABSTRACT

The invention relates to sunshade base. It is an assembled sunshade base comprising an erecting tubular member and a base member. The base member further includes a ground frame having cross-bar being surrounded by a wall to form plurality of cavities for accommodating a ballast member. The ballast member consists of many individual containers filled with ballast materials such as water or sand. The erecting tubular member for receiving a pole of sunshade or large umbrella is uprightly secured on the base. There is a cover detachly secured on the upper surface of the base. Most of the parts is detachable and can be quickly assembled.

### FIELD OF THE INVENTION

The present invention relates to a large umbrella or sunshade, more particularly it relates to the base member of the large umbrella or sunshade.

### BACKGROUND OF THE INVENTION

A large umbrella or sunshade is bulky and heavy, and thus requires a base to provide stable support. The currently used large umbrella or sunshade has a casting iron or concrete—made base member which has a considerable weight of about several tens of kilograms. As a result, it is difficult and inconvenient to move the sunshade to a desired position. Other attempts to give support for large umbrella or sunshade were made in the past, such as using a cross-bar as a base frame, on which there are some stone or cake of concrete being piled up as ballast members. But it is ugly in appearance of sunshade.

In view of the drawbacks above mentioned it is therefore an object of the present invention to provide an assembly base as a stable support for sunshade with the merits of being light in weight, easy to move, low in cost, to overcome the problems existing in the prior art.

### SUMMARY OF THE INVENTION

According to the present invention, an assembled sunshade base is provided for anchoring a sunshade comprising a ground frame with bar members, an erecting tubular member for receiving a pole of sunshade, and a plurality of containers as ballast members, which are detachable from each other. The ballast members are rechargeable with ballast material such as water. Specifically it has following components,

a cross-bar(four bars) of ground frame which contacts with ground, joining together with a peripheral wall to form plurality of cavities for receiving ballast members. It is also feasible that the ground frame has three or other numbers of bars which inner ends mutually intersect at the center of the said base.

an erecting tubular member for receiving a pole of the sunshade is uprightly secured on the cross-bar of ground frame, after the pole of the sunshade being inserted into the erecting tubular member, turning the positioning screw members positioned on the tube-wall to secure the pole inside the tube.

a connecting plate being placed over the upper surface and at the center part of the cross-bar of the ground frame for engaging with the erecting tubular member and the cross-bar mutually is secured on the cross-bar by screw members.

a plurality of cavities formed by the cross-bar and peripheral wall are occupied by ballast containers which may be flexible or hard one having a fixed configuration and shape. Plastic or rubber bag can be used as the container.

a ballast member being formed by connecting plurality of individual containers. Between adjacent individual containers there is a connecting part. As an integral one, it has substantially a flat top surface after the individual ones being inserted into the cavities formed by the cross-bar of the ground frame and the peripheral wall. The connecting parts between each adjacent container have passage for communicating the chambers of the adjacent containers. On the top surface of the container there is a port, through which the ballast material, for example water, can be filled into or discharged out. On the port of the container there is a cup for sealing the water therein. A through hole is provided at the center part of the ballast member for the erecting tubular member passing through Besides water, sand and the like can also be used as a ballast material. In this case, preferably each individual container has its own port with a cap on the top surface thereof. In other words, the integral of the multiple-containers as a ballast member would have four ports. If the individual containers are hard, and has a fixed configuration, its shape is the same as the shape of the cavities. Sand can be filled in a sausage like plastic or rubber bag, being used as a ballast means. Owing to the flexibility of the plastic bag and the shapelessness of sand, it is easy to fully fill into the cavities formed by the bars and the walls.

a cover being placed on the top surface of the container for an aesthetic exterior look of the base. On the other hand, the cover and the wall of the base can protect the containers from damages.

Before assembly, the cover, the ballast container, the connecting plate and the erecting tubular member, and the bar member, as well as the peripheral walls are all separately stored in a package, therefore it is convenient to carry or transport. All the members aforesaid can be quickly assembled into an integral base for supporting a sunshade or large umbrella in garden or on beach.

### BRIEF DESCRIPTION OF THE DRAWINGS

FIG. 1 illustrates an assembled sunshade base of the invention;

FIG. 2 shows an assembled sunshade base without the ballast means;

FIG. 3 shows an assembled sunshade base with the ballast containers but without the cover;

FIG. 4 shows the integral ballast container only.

### DETAILED DESCRIPTION OF THE PREFERRED EMBODIMENT

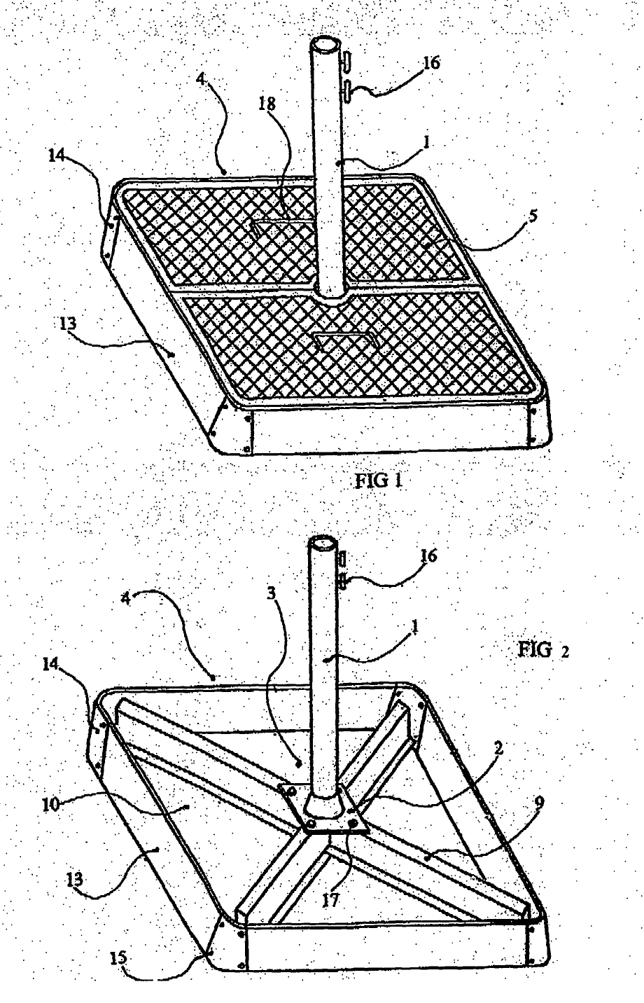

FIG. 1 shows preferred assembled sunshade base. An assembled sunshade base for anchoring a sunshade comprising a cross-bar ground frame 3 as a base member, a peripheral wall 4 surrounding the cross-bar, an erecting tubular member 1, a connecting plate 2 and a plurality of containers 8 as ballast members.

A cross-bar ground frame 3 which is in contacts with ground, joins together with a peripheral wall to form plurality of cavities for receiving ballast members (see FIG. 2).

An erecting tubular member 1 for receiving a pole (not shown) of the sunshade is uprightly and detachablely secured on the cross-bar 9 with screw means (see FIG. 2). After the pole of the sunshade is inserted into the erecting tubular member, turning the screw 16 positioned on the tube-wall to secure the pole (not shown) in the same.

A connecting plate 2 being placed over and at the center part of the cross-bar ground frame for engaging with the erecting tubular member 1 and the cross-bar 9 therebetween is secured to an upper surface of the cross-bar 9 of the ground frame by screw members 17.

A plurality of cavities 10 formed by the cross-bar 9 and peripheral wall 13 are occupied by ballast container 6 which may be flexible or hard one, without or having a fixed configuration and shape.

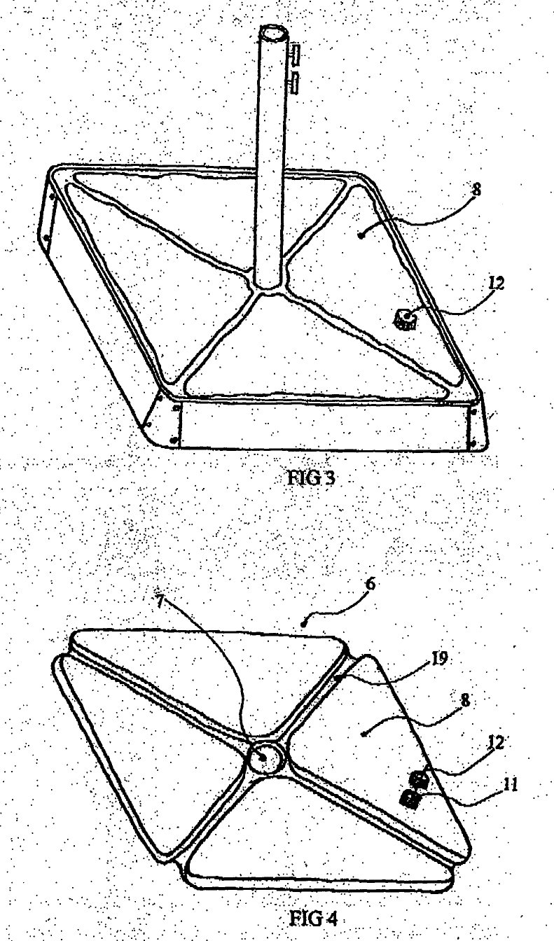

The ballast means 6 is formed by connecting a plurality of individual containers 8, between which there are connecting parts 19. As an integral one 6, it has substantially a flat shape after being inserted into the cavities 10 formed by the cross-bar 9 and the peripheral wall 13 (refer to FIG. 3). The connecting parts 19 between each adjacent container 8 have a passage (not shown) for communicating the chambers of the adjacent containers 8. On the top surface of the container 8 there is a port 11, through which the ballast material, for example water, can be filled into or discharged out. On the port 11 of the container 6 there is a cup 12 for sealing the water therein (see FIG. 4). A through hole 7 is provided at the center part of the flat integrity of the ballast container for the erecting tubular member passing through. Besides water, sand and the like can also be used as a ballast material. In this case, preferably each individual container 8 has their own port 11 with a cap 12 on the top surfaces thereof. In other words, the integral of the multiple-containers 6 as a ballast member would have four ports 11 (not shown).

A cover 5 is placed on the top surface of the container, for aesthetic exterior look of the base. There are grasps 18 on the upper surface of the cover 5 (see FIG. 1) for grasping when the cover 5 is put onto the base or taken off from the base. On the other hand, the cover and the wall of the base can protect the containers from damages.

The wall consists of four straight metal stripes 13 and four corner members 14. The corner members 14 have an arch shape, and are connected together with by screw 15 forming a rectangular wall (FIG. 2).

The illustration and examples provided herein are for explanatory purposes only. Although one embodiment of the invention is shown and described in the figures, the invention is not limited to the above description and includes a variety of specific designs. The invention is not necessarily limited to the specific construction as illustrated and described, since such construction is only intended to be illustrative of the principle of operation.

What is claimed is:

1. An assembled sunshade base for anchoring an sunshade comprising a base with ballast adapted to engage with a pole of a sunshade, which further comprising:
a ground frame which contacts with ground, joining together with a peripheral wall forming plurality of cavities for receiving ballast members, which has plurality of bars surrounded by said peripheral wall;
an erecting tubular member for receiving a pole of the sunshade being uprightly secured on said ground frame;
a connecting means for connecting said erecting tubular member and said bar members joining together;
a peripheral wall surrounding said bar members;
a ballast means accommodated in said plurality of cavities; and
a cover being secured on the upper surface of said ballast means and said ground frame is removable.

2. An assembled sunshade base of claim 1, wherein said ground frame has four bars which exhibits a cross-intersected shape, and surrounded by said peripheral wall.

3. An assembled sunshade base of claim 1, wherein said ground frame has three bars which inner ends intersect at the center of the said base, and surrounded by said peripheral wall.

4. An assembled sunshade base of claim 1, wherein said ballast means comprises a plurality of individual containers which has a fixed configuration as same as the shape of said cavities.

5. An assembled sunshade base of claim 1, wherein said ballast mean is a plastic or rubber bag filled with sand, which has a sausage like shape.

6. An assembled sunshade base of claim 4, wherein there is a connecting part between each adjacent individual containers, within which there is a passage for communicating the chamber of two adjacent containers.

7. An assembled sunshade base of claim 1, wherein said peripheral wall can comprises four straight stripes and four corner members, the said corner members have an arch shape, being bonded together with by screw forming a rectangular peripheral wall for surrounding the bar members.

8. An assembled sunshade base of claim 1, wherein between erecting tubular member and ground frame there is a connecting plate for securing said erecting tubular member upstanding on said cross-bar of said ground frame.

9. An assembled sunshade base of claim 1, wherein on the top surface of said container there is a port, through which the ballast material can be filled or discharged, on the port of said container there is a cup for sealing the water therein, and there is a through hole at the center of said ballast means for the erecting tubular member passing through.
